(19) United States
(12) Patent Application Publication
(10) Pub. No.: US 2010/0158269 A1
(43) Pub. Date: Jun. 24, 2010

(54) Method and apparatus for reducing wind noise

(75) Inventor: Chen Zhang, Beijing (CN)

Correspondence Address: SILICON VALLEY PATENT AGENCY, 7394 WILDFLOWER WAY, CUPERTINO, CA, 95014, US

(73) Assignee: Vimicro Corporation

(21) Appl. No.: 12/475,525

(22) Filed: May 31, 2009

(30) Foreign Application Priority Data
Dec. 22, 2008 (CM) 200810240479.0

(51) Int. Cl. H04B 15/00

(52) U.S. Cl. 381/94.2

(57) ABSTRACT

Techniques pertaining to techniques to reduce wind noises effectively in recorded signals are disclosed. According to one aspect of the present invention, there is a strong correlation between two voice signals from target voices in the same frequency band sampled simultaneously by a pair of microphones in a common scene while there is a weak correlation between wind noises in the same frequency band of the two voice signals sampled simultaneously by the pair of microphones in the common scene. Taking advantage of this feature to provide a larger gain to the frequency band having a strong correlation and a smaller gain to the frequency band having a weak correlation, thereby the wind noise is reduced efficiently with minimum impact on the target voices.

### BACKGROUND OF THE INVENTION

1. Field of the Invention

The present invention relates to the area of audio signal processing, more particularly to method and apparatus for reducing wind noise.

2. Description of Related Art

The wind may introduce an annoying noise when voice recording in outdoors. Especially in strongly windy conditions, the wind noise recorded by a microphone may be too big to almost overcome a target voice desired to be recorded.

The fast-moving gas forms a rotating airflow around the microphone to generate the wind noise. In general, the wind noise is mainly concentrated in low frequency bands. FIG. 1 is a curve diagram showing the frequency characteristics of the wind noise. The most of energy of the wind noise is concentrated in the frequency under 1 Khz, and the energy of the wind noise arrives at a peak in the frequency of 100-200 Hz.

Generally, a windscreen may be used to weaken the impact of the wind noise. However, many small devices, e.g. a digital video camera or a recording pen, is not equipped with a windscreen, so the impact of the wind noise is inevitable. Additionally, a high pass filter is used to reduce the wind noise since the wind noise mainly comprises a low band component. However, low band components of the voice itself are also cut in addition to the wind noise, the quality of the recoding sound is decreased.

Thus, improved techniques for method and device for reducing wind noise are desired to overcome the above disadvantages.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, the present invention pertains to improved techniques to reduce wind noise effectively in recorded signals. In one aspect of the present invention, there is a strong correlation of two voice signals from target voices in the same frequency band sampled simultaneously by a pair of microphones in a common scene while there is a weak correlation of wind noises in the same frequency band of the two voice signals sampled simultaneously by the pair of microphones in the common scene. Taking advantage of this feature to provide a larger gain to the frequency band having a strong correlation and a smaller gain to the frequency band having weak correlation, thereby the wind noise is reduced efficiently with minimum impact on the target voices.

One of the features, benefits and advantages in the present invention is to provide techniques to remove wind noises with minimum impact on recorded signals.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 is a curve diagram showing a frequency characteristic of wind noise;

FIG. 2 is a block diagram showing a device for reducing wind noise according to one embodiment of the present invention;

FIG. 3 is a schematic diagram showing a frequency characteristic of a band pass filter;

FIG. 4 is a block diagram showing an exemplary configuration of a wind noise reduction module according to one embodiment of the present invention; and

FIG. 5 is a flow chart showing a method for reducing wind noise according to one embodiment of the present invention.

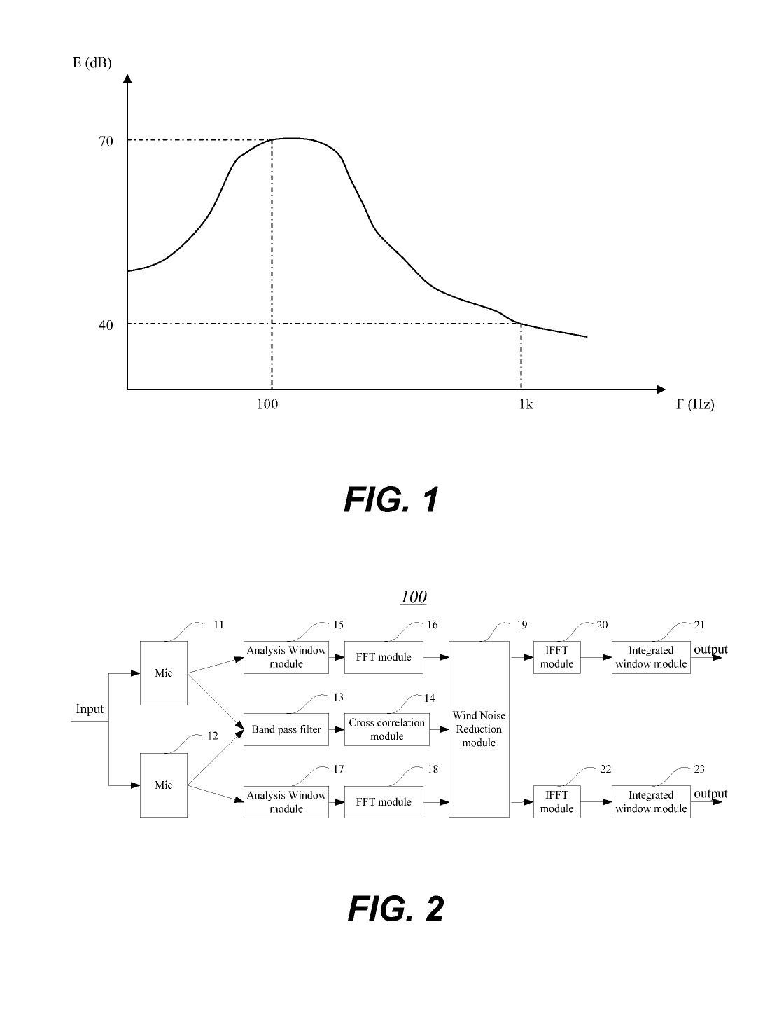

### DETAILED DESCRIPTION OF THE INVENTION

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams or the use of sequence numbers representing one or more embodiments of the invention do not inherently indicate any particular order nor imply any limitations in the invention.

Embodiments of the present invention are discussed herein with reference to FIGS. 2-5. However, those skilled in the art will readily appreciate that the detailed description given herein with respect to these figures is for explanatory purposes only as the invention extends beyond these limited embodiments.

Improved techniques are provided to reduce wind noises effectively according to one embodiment of the present invention. It can be seen that a correlation of target voices in the same frequency band of two voice signals sampled simultaneously by a pair of microphones in a common scene is strong, and a correlation of wind noises in the same frequency band of the two voice signals sampled simultaneously by the pair of microphones in the common scene is very weak. Taking advantage of this feature to provide a larger gain to the frequency band having strong correlation and a smaller gain to the frequency band having weak correlation, thereby the wind noise is reduced efficiently with minimum impact on the target voices.

FIG. 2 is a block diagram showing a device 100 for reducing wind noise according to one embodiment of the present invention. Referring to FIG. 2, the device comprise a pair of microphones 11 and 12, a band pass filter 13, a cross correlation module 14, a pair of analysis window modules 15 and 17, a pair of FFT (Fast Fourier Transform Algorithm) module 16 and 18, a wind noise reduction module 19, a pair of IFFT (Inverse Fast Fourier Transform Algorithm) modules 20 and 22, and a pair of integrated window modules 21 and 23.

The microphones 11 and 12 are configured to sample two voice signals (e.g. a left or first voice signal and a right or second voice signal) simultaneously in a common scene, output the two voice signals to the band pass filter 13, and output the two voice signals to the analysis window module 15 and the analysis window module 16 respectively.

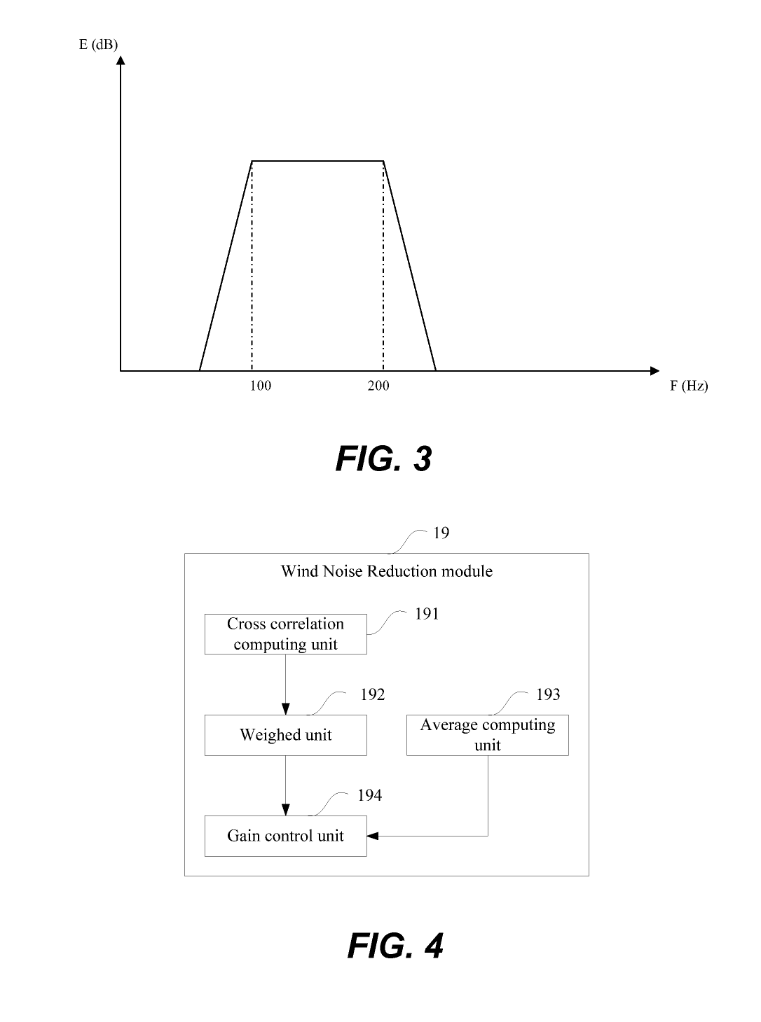

FIG. 3 is a schematic diagram showing a frequency characteristic of the band pass filter 13. The band pass filter 13 is configured to pass the two voice signals within a certain frequency range and reject the two voice signals outside the certain frequency range. The certain frequency range is about 100-200 Hz since the energy of the wind noise is mainly concentrated in a frequency range of 100-200 Hz.

The cross correlation module 14 is configured to calculate a cross correlation of the two voice signals within the frequency range of 100-200 Hz to determine whether the two voice signals sampled currently contain the wind noise. The two voice signals processed by the band pass filter 13 is denoted as ×1 and ×2, and the following calculations is performed by the cross correlation module 14:

$$Corr x 1 x 2 = {\sum }_{K = 0}^{N - 1} x 1 ( k ) x 2 ( k ) ;$$

$$Corr x 1 = {\sum }_{K = 0}^{N - 1} x 1 ( k ) x 1 ( k ) ;$$

$$Corr x 2 = {\sum }_{K = 0}^{N - 1} x 2 ( k ) x 2 ( k ) .$$

where Corr×1×2 is a cross correlation of ×1 and ×2, Corr×1 is a self correlation of ×1, and Corr×2 is a self correlation of ×2 . So, the normalized cross correlation corr×1×2 of ×1 and ×2 is:

$$corr x 1 x 2 = \frac{Corr x 1 x 2}{\sqrt{Corr x 1 * Corr x 2}} .$$

where corr×1×2 is a number between 0 and 1 and reflects a cross correlation between the two voice signals. It is indicated that the two voice signals contain the wind noise if the value of corr×1×2 approximates to 1. It is indicated that the two voice signals don't contain the strong wind noise if the value of corr×1×2 approximates to 0. The cross correlation module 14 outputs the normalized cross correlation corr×1×2 to the wind noise reduction module 19. Hence, the corr×1×2 is used as an overall probability parameter to determine whether the two voice signals contain the wind noise.

The analysis window modules 15 and 17 are configured to process the two voice signals with analysis window respectively. The FFT (Fast Fourier Transform Algorithm) modules 16 and 18 are configured to convert the processed two voice signals in a time domain to the two voice signals in a frequency domain respectively. The two voice signals in the frequency domain are sent to the wind noise reduction module 19.

FIG. 4 is a block diagram showing an exemplary configuration of the wind noise reduction module 19 according to one preferred embodiment of the present invention. The wind noise reduction module 19 comprises a cross correlation computing unit 191, a weighted unit 192, an average computing unit 193 and a gain control unit 194.

The cross correlation computing unit 191 is configured to calculate a cross correlation of the two voice signals in the frequency domain to obtain a normalized cross correlation corrLR(i) of each frequency band of the two voice signals in the frequency domain within the frequency range of under 1000 Hz, wherein i is a number of the frequency band of the two voice signals in the frequency domain.

The weighted module 192 is configured to weigh the normalized cross correlation corrLR(i) of each frequency band depending on the overall normalized cross correlation corr×1×2 to get an weighted normalized cross correlation corrLR′(i).

The average computing unit 193 is configured to compute an average value of the two voice signals within the frequency range of 0-1000 Hz.

The gain control unit 194 is configured to control a gain of the average value of the two voice signals within the frequency range of 0-1000 Hz depending on the weighted normalized cross correlation corrLR′(i).

The operations of the wind noise reduction module 19 are described in detail hereafter. A real part of an ith frequency band of the voice signal inputted from the microphone 11 is denoted as Re_L(i), and an imaginary part of the ith frequency band of the voice signal inputted from the microphone 11 is denoted as Re_L(i). A real part of an ith frequency band of the voice signal inputted from the microphone 12 is denoted as Re_R(i), and an imaginary part of the ith frequency band of the voice signal inputted from the microphone 12 is denoted as Re_R(i).

The following calculations is performed by the cross correlation computing unit 191:

CorrLR(i)=Re_{—}L(i)*Re_{—}R(i)+Im_{—}L(i)*Im_{—}R(i);

CorrLL(i)=Re_{—}L(i)*Re_{—}L(i)+Im_{—}L(i)*Im_{—}L(i);

CorrRR(i)=Re_{—}R(i)*Re_{—}R(i)+Im_{—}R(i)*Im_{—}R(i).

Wherein CorrLR(i) is a cross correlation of the ith frequency band of the voice signal from the microphone 11 and the voice signal from the microphone 12, CorrLL(i) is a self correlation of the ith frequency band of the voice signal from the microphone 11, CorrRR(i) is a self correlation of the ith frequency band of the voice signal from the microphone 12. So, the normalized cross correlation corrLR(i) of the ith frequency band of the two voice signals is:

$$corr LR ( i ) = \frac{Corr LR ( i )}{\sqrt{Corr LL ( i ) * Corr RR ( i )}} .$$

The cross correlation of the two voice signals within the frequency range of under 1000 Hz is required to be calculated since the wind noise is mainly concentrated in the frequency under 1 Khz. Wherein i=0˜N/8 if FFT points is N and a sampling rate is 8 Khz. It is noted that the corrLR(i) may be used as a partial probability parameter to determine where the ith frequency band of the two voice signals contains the wind noise.

The weighted module 192 gets the weighted normalized cross correlation corrLR′(i) according to the following equation:

corrLR′(i)=corrLR(i)*corr×1×2.

The average computing unit 193 computes the average value of the two voice signals within the frequency range of 0-1000 Hz according to the following equations:

Re(i)=(Re_{—}L(i)+Re_{—}R(i))/2;

Im(i)=(Im_{—}L(i)+Im_{—}R(i))/2.

Because the target voices in the two voice signals have a strong correlation and the wind noises in the two voice signals almost have no correlation, the average of the two voice signals has no effect to the target voices, but makes an attenuation of 6 dB to the wind noise. Thereby, the signal to noise ratio of the voice signal is enhanced.

The gain control unit 194 control the gain of the average value of the two voice signals according to the following equations:

Re_out(i)=Re(i)*corrLR′(i);

Im_out(i)=Im(i)*corrLR′(i).

The value of corrLR′(i) is lower if the ith frequency band contains the stronger wind noise, so the values of Im_out(i) and Re_out(i) are smaller. In other words, the smaller gain is provided to the frequency band signal containing the stronger wind noise. The value of corrLR′(i) is higher if the ith frequency band contains the weaker wind noise, so the values of Im_out(i) and Re_out(i) are larger. In other words, the larger gain is provided to the frequency band signal containing the weaker wind noise. Thereby, the signal to noise ratio of the voice signal is further enhanced.

Re_out(i) is the real part of the voice signal, and Im_out(i) is the imaginary part of the voice signal. The voice signal consisting of Re_out(i) and Im_out(i) is duplicated to replace the two voice signals from the microphone 11 and the microphone 12 in the same frequency band. The two voice signals

The IFFT modules 20 and 22 are configured to convert the two voice signals in the frequency domain from the wind noise reduction module 19 back to the two voice signals in the time domain respectively. The integrated window modules 21 and 23 are configured to process the two voice signals to get the final two voice signals with the wind noise reduced respectively.

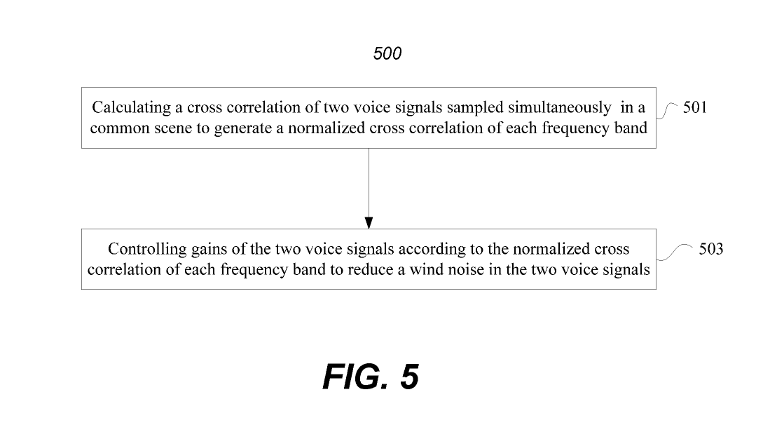

FIG. 5 is a flow chart showing a method 500 for reducing wind noise according to one embodiment of the present invention. Referring to FIG. 5, the method 500 comprises the following operations.

At 501, a cross correlation of two voice signals sampled simultaneously in a common scene is calculated to generate a normalized cross correlation corrLR(i) of each frequency band of the two voice signals.

At 502, gains of the two voice signals is adjusted according to the normalized cross correlation value of each frequency band of the two voice signals to reduce the wind noise in the two voice signals.

In a preferred embodiment, the method 500 further comprises the following operation before 501. The two voice signals are band pass filtered with a certain frequency range thereof passed and other frequency range thereof rejected. The certain frequency range is about 100-200 Hz since the energy of the wind noise is mainly concentrated in a frequency range of 100-200 Hz. A normalized cross correlation corr×1×2 of the two voice signals within the certain frequency range is calculated to determine whether the two voice signals contain the wind noise. The normalized cross correlation corrLR(i) of each frequency band is weighted depending on the normalized cross correlation corr×1×2 to get an weighted normalized cross correlation corrLR′(i). So, the gains of the two voice signals is adjusted according to the weighted normalized cross correlation corrLR′(i) of each frequency band of the two voice signals to reduce the wind noise in the two voice signals.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

What is claimed is:

1. A method for reducing a noise, the method comprising:
calculating a cross correlation of two voice signals sampled simultaneously in a common scene to generate a normalized cross correlation of each frequency band of the two voice signals; and
adjusting gains of the two voice signals according to the normalized cross correlation of each frequency band of the two voice signals to reduce the noise contained in the two voice signals.

2. The method according to claim 1, wherein the calculating a cross correlation of two voice signals sampled simultaneously in a common scene to generate a normalized cross correlation of each frequency band of the two voice signals comprises:
transforming the two voice signals sampled simultaneously in the common scene via FFT; and
calculating the cross correlation of the two voice signals after FFT to generate the normalized cross correlation of each frequency band of the two voice signals;

3. The method according to claim 1, wherein the adjusting gains of the two voice signals according to the normalized cross correlation of each frequency band of the two voice signals to reduce noise contained in the two voice signals comprises:
filtering the two voice signals to pass the two voice signals within a certain frequency range and reject the two voice signals outside the certain frequency range;
calculating a cross correlation of the filtered two voice signals to generate a normalized cross correlation of the filtered two voice signals;
weighing the normalized cross correlation of each frequency band depending on the normalized cross correlation of the filtered two voice signals to generate an weighted normalized cross correlation; and
adjusting the gains of the two voice signals according to the weighted normalized cross correlation.

4. The method according to claim 3, wherein the adjusting the gains of the two voice signals according to the weighted normalized cross correlation comprises:
computing an average value of each frequency band of the two voice signals: and
adjusting the gain of the average value of each frequency band according to the weighted normalized cross correlation.

5. The method according to claim 1, wherein the normalized cross correlation of each frequency band is the normalized cross correlation of each frequency band within 0-1000 Hz.

6. A device for reducing noise, comprising:
a cross correlation computing unit configured for calculating a cross correlation of two voice signals sampled simultaneously in a common scene to generate a normalized cross correlation of each frequency band of the two voice signals;
a gain control unit configured for adjusting gains of the two voice signals according to the normalized cross correlation of each frequency band of the two voice signals to reduce noise contained in the two voice signals.

7. The device according to claim 6, further comprising:
a pair of microphones configured for sampling the two voice signals simultaneously in the common scene; and
a pair of FFT module configured for transforming the two voice signals in a time domain to the two voice signals in a frequency domain, and outputting the two voice signals in a frequency domain to the cross correlation computing unit.

8. The device according to claim 7, further comprising:
a band pass filter configured for passing the two voice signals sampled by the microphones within a certain frequency range and rejecting the two voice signals outside the certain frequency range;
a cross correlation module configured for calculating a cross correlation of the two voice signals from the band pass filter to generate an overall normalized cross correlation of the two voice signals;
a weighted unit configured for weighing the normalized cross correlation of each frequency band of the two voice signals depending on the overall normalized cross correlation of the two voice signals to generate an weighted normalized cross correlation; and wherein
the gain control unit adjusts the gains of the two voice signals according to the weighted normalized cross correlation.

9. The device according to claim 8, further comprising:
an average computing unit configured for computing an average value of each frequency band of the two voice signals; and wherein
the gain control unit adjusts the gain of the average value of each frequency band according to the weighted normalized cross correlation.

10. The device according to claim 6, wherein the normalized cross correlation of each frequency band is the normalized cross correlation of each frequency band within 0-1000 Hz.

11. A method for reducing wind noise, comprising:
calculating a cross correlation of two voice signals sampled simultaneously in a common scene to generate a normalized cross correlation of each frequency band of the two voice signals;
computing an average value of each frequency band of the two voice signals;
adjusting a gain of the average value of each frequency band according to the normalized cross correlation of corresponding frequency band of the two voice signals; and
generating corresponding frequency band of an output voice signal by processing the average value of each frequency band according to corresponding adjusted gain.

12. The method according to claim 11, wherein the adjusting gains of the two voice signals according to the normalized cross correlation of each frequency band of the two voice signals to reduce noise contained in the two voice signals comprises:
filtering the two voice signals to pass the two voice signals within a certain frequency range and reject the two voice signals outside the certain frequency range;
calculating a cross correlation of the filtered two voice signals to generate a normalized cross correlation of the filtered two voice signals;
weighing the normalized cross correlation of each frequency band depending on the normalized cross correlation of the filtered two voice signals to generate an weighted normalized cross correlation; and
adjusting the gain of the average value of each frequency band according to the weighted normalized cross correlation.
